(19) United States
(12) Patent Application Publication
(10) Pub. No.: US 2018/0321561 A1
(43) Pub. Date: Nov. 8, 2018

(54) TOUCH DISPLAY DEVICE

(71) Applicant: Chunghwa Picture Tubes, LTD., Taoyuan City (TW)

(72) Inventor: Jiun-Jr Huang, Yilan County (TW)

(73) Assignee: Chunghwa Picture Tubes, LTD., Taoyuan City (TW)

(21) Appl. No.: 15/619,091

(22) Filed: Jun. 9, 2017

(30) Foreign Application Priority Data
May 5, 2017 (CN) 201720490834.4

(51) Int. Cl. G02F 1/1362; G06F 3/041; G06F 3/044; G02F 1/1333; G02F 1/1335; G02F 1/1343

(52) U.S. Cl. CPC G02F 1/136204; G06F 3/0412; G06F 3/044; G02F 1/13338; G02F 2202/22; G02F 1/134309; G02F 2001/134372; G02F 2202/28; G02F 1/133528

(57) ABSTRACT

A touch display device including a lower substrate, an active device array disposed on the lower substrate, a passivation layer covering the active device array, touch electrodes disposed on the passivation layer, an upper substrate, a display medium disposed between the upper substrate and the touch electrodes, an upper polarizing plate and a signal transmission line is provided. Δε of the display medium is smaller than 0. The upper polarizing plate is disposed at one side of the upper substrate located away from the display medium, and has an adhesion layer to adhere the upper polarizing plate and the upper substrate, where a sheet resistance of the adhesion layer is smaller than or equal to 10⁹Ω/□. The signal transmission line is disposed in a non-display area, and has a first end and a second end respectively connected to the adhesion layer and the lower substrate.

### CROSS-REFERENCE TO RELATED APPLICATION

This application claims the priority benefit of China application serial no. 201720490834.4, filed on May 5, 2017. The entirety of the above-mentioned patent application is hereby incorporated by reference herein and made a part of this specification.

### BACKGROUND OF THE INVENTION

### Field of the Invention

The invention relates to a display device, and particularly relates to a touch display device.

### Description of Related Art

Touch display devices have both of a touch function and a display function, and can be divided into out-cell touch display devices, on-cell touch display devices and in-cell touch display devices according to different structures thereof. The in-cell touch display device is to integral the touch function in internal of a display panel, which has the thinnest overall thickness, and is generally applied to high-class products requiring a thin appearance.

In the past, in the out-cell touch display device or the on-cell touch display device, an indium tin oxide (ITO) layer is generally coated on a upper substrate (for example, a color filter substrate) of the display device to transfer static electricity to external of the touch display device, so as to avoid unstableness or damage of the touch display device caused by electrostatic discharge (ESD). However, the in-cell touch display device cannot expel the static electricity by using the same method, and it is liable to cause malfunction of the touch display device due to the ESD.

### SUMMARY OF THE INVENTION

The invention is directed to a touch display device, which is adapted to improve resistance ability to electrostatic discharge (ESD), and maintain an optical taste.

The invention provides a touch display device including a lower substrate, an active device array, a passivation layer, a plurality of touch electrodes, an upper substrate, a display medium, an upper polarizing plate and a signal transmission line. The active device array is disposed on the lower substrate. The passivation layer covers the active device array. The plurality of touch electrodes is disposed on the passivation layer. The upper substrate is disposed opposite to the lower substrate. The display medium is disposed between the upper substrate and the plurality of touch electrodes, and Δε of the display medium is smaller than 0. The upper polarizing plate is disposed at one side of the upper substrate located away from the display medium. The upper polarizing plate has an adhesion layer to adhere the upper polarizing plate and the upper substrate, where a sheet resistance of the adhesion layer is smaller than or equal to 10⁹Ω/□. The signal transmission line is disposed in a non-display area of the touch display device. The signal transmission line has a first end and a second end, where the first end is electrically connected to the adhesion layer, and the second end is electrically connected to the lower substrate.

In an embodiment of the invention, the touch display device may adapt to withstand ESD of 8 kV.

In an embodiment of the invention, the plurality of touch electrodes may include a plurality of sensing electrodes and a plurality of driving electrodes.

In an embodiment of the invention, each active device in the active device array may overlap with the plurality of touch electrodes in a direction perpendicular to the lower substrate.

In an embodiment of the invention, the touch display device may further includes an insulation layer. The insulation layer is disposed between the active devices and the plurality of touch electrodes to make the plurality of touch electrodes to be close to the upper substrate.

In an embodiment of the invention, the adhesion layer may have a plurality of antistatic particles.

In an embodiment of the invention, the first end of the signal transmission line may directly contact the adhesion layer.

In an embodiment of the invention, the first end of the signal transmission line may misalign with the plurality of touch electrodes in a direction perpendicular to the lower substrate.

In an embodiment of the invention, the signal transmission line may have a main body, and the first end and the second end of the signal transmission line are located at two ends of the main body. The main body directly contacts the upper substrate.

In an embodiment of the invention, the touch display device may further includes a bonding part. The bonding part is disposed on the lower substrate and located in the non-display area. The second end of the signal transmission line is electrically connected to the bonding part to transmit static electricity to external of the touch display device.

According to the above description, in the touch display device of the invention, the upper polarizing plate has the adhesion layer with a sheet resistance smaller than or equal to 10⁹Ω/□, and the first end of the signal transmission line configured in the non-display area is electrically connected to the adhesion layer, and the second end of the signal transmission line is electrically connected to the lower substrate. In this way, in case of the ESD, the static electricity is transmitted to external of the touch display device without influencing a touch function. Particularly, the display medium has Δε smaller than 0, and is not easy to be interfered by the ESD.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a touch display device according to an embodiment of the invention.

### DESCRIPTION OF EMBODIMENTS

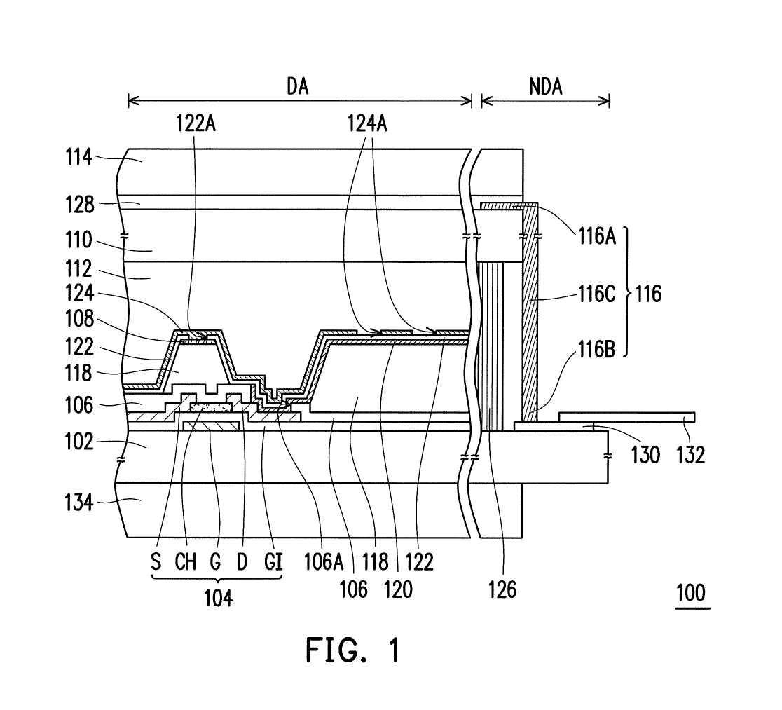

FIG. 1 is a schematic diagram of a touch display device according to an embodiment of the invention. In FIG. 1, only one pixel structure of the touch display device is illustrated for description. Generally, a display device is formed by a plurality of pixel structures arranged in an array, and those skilled in the art may learn the structure of the touch display device of the invention according to the specification and description of the FIGURE.

Referring to FIG. 1, the touch display device 100 includes a lower substrate 102, an active device array (including a plurality of active devices 104), a passivation layer 106, a plurality of touch electrodes 108, an upper substrate 110, a display medium 112, an upper polarizing plate 114 and a signal transmission line 116. The touch display device 100 has a display area DA and a non-display area NDA, and an edge of the display medium 112 may serve as a boundary of the display area DA and the non-display area NDA.

The active device array including a plurality of the active devices 104 is located in the display area DA and disposed on the lower substrate 102. The lower substrate 102 is mainly used for carrying various component of the touch display device 100. The lower substrate 102 can be a flexible substrate or a rigid substrate. A material of the flexible substrate includes plastic or glass, though the invention is not limited thereto. A material of the rigid substrate includes glass or silicon wafer, though the invention is not limited thereto. In the present embodiment, the active device 104 is, for example, a thin-film transistor (TFT), though the invention is not limited thereto. In other embodiments, the active device 104 may include other components other than the thin-film transistor, for example, a capacitor, a transmission line, etc. The TFT has a source S, a gate G, a drain D, a gate insulation layer GI and a semiconductor layer CH. The source S and the drain D are electrically connected to two sides of the semiconductor layer CH. The gate G is overlapped with the semiconductor layer CH in a direction perpendicular to the lower substrate 102. The gate insulation layer GI can be configured between the source S/drain D and the gate G to electrically isolate the source S/drain D from the gate G. In the present embodiment, the gate G can be configured between the semiconductor layer CH and the lower substrate 102. In other words, the gate G can be disposed under the semiconductor layer CH, and the active device 104 can be a bottom gate TFT. However, the invention is not limited thereto, and in other embodiments, the active device 104 can also be a top gate TFT or other proper types of TFT.

The passivation layer 106 covers the active device array including the active devices 104, and has a first opening 106A exposing the drain D. The plurality of touch electrodes 108 are disposed on the passivation layer 106, and each of the active devices 104 in the active device array is overlapped with the plurality of touch electrodes 108 in the direction perpendicular to the lower substrate 102. Moreover, in an embodiment of the invention, the active devices 104 and the plurality of touch electrodes 108 may include other layers there between. For example, an insulation layer 118 can be disposed between the active devices 104 and the plurality of touch electrodes 108. The insulation layer 118 can be a single layer or multiple layers, and the number thereof is not particularly specified. In the present embodiment, the insulation layer 118 is, for example, a single layer, and has a structure protruding from the lower substrate 102 toward the upper substrate 110 to make the plurality of touch electrodes 108 to be close to the upper substrate 110. The plurality of touch electrodes 108 may include a plurality of sensing electrodes and a plurality of driving electrodes, so as to form sensing capacitors to serve for touch sensing. A material of the touch electrode 108 can be a transparent or opaque conductive material. The transparent conductive material is, for example, indium tin oxide (ITO), and the opaque conductive material is, for example, metal, alloy or a stacked layer of metal and other conductive materials.

In the present embodiment, the touch display device 100 may further include a pixel electrode 120, another insulation layer 122 and a common electrode 124. The pixel electrode 120 is disposed on the insulation layer 118, and is electrically connected to the active device 104. In detail, the pixel electrode 120 is filled in the first opening 106A of the passivation layer 106 for electrically connecting the drain D of the active device 104. The insulation layer 122 covers the touch electrode 108 and the pixel electrode 120, and the insulation layer 122 has a second opening 122A exposing the touch electrode 108. The common electrode 124 is disposed on the insulation layer 122, and is filled in the second opening 122A for electrically connecting the touch electrode 108. The common electrode 124 has a plurality of slits 124A, and the slits 124A are misaligned with the active device 104 in the direction perpendicular to the lower substrate 102, and expose the pixel electrode 120. The common electrode 124 and the pixel electrode 120 are separated by the insulation layer 122, and are respectively located on an upper and a lower surfaces of the insulation layer 122. In other words, in the present embodiment, the touch display device 100 includes a fringe field switching (FFS) display device.

The upper substrate 110 and the lower substrate 102 are disposed opposite to each other. In an embodiment of the invention, the upper substrate 110 can be configured with a color filter layer (for example, a red filter layer, a green filter layer and a blue filter layer) or a black matrix (BM), etc. The upper substrate 110 can be a flexible substrate or a rigid substrate. A material of the flexible substrate includes plastic or glass, though the invention is not limited thereto. A material of the rigid substrate includes glass, though the invention is not limited thereto. In an embodiment of the invention, the material of the upper substrate 110 can be the same or different with the material of the lower substrate 102.

The display medium 112 is disposed between the upper substrate 110 and the plurality of touch electrodes 108. In detail, a sealing member 126 is applied to separate a gap between the upper substrate 110 and the lower substrate 102, and the display medium 112 is filled in the gap, such that the display medium 112 can be disposed between the upper substrate 110 and the plurality of touch electrodes 108. In the present embodiment, a dielectric coefficient ε_{∥} of a long axis of the display medium 112 is smaller than a dielectric coefficient ε_{⊥} of a short axis thereof, such that Δε of the display medium 112 is smaller than 0, where Δε=ε_{∥}−ε_{⊥}. In other words, the display medium 112 can be negative liquid crystal. In this way, the display medium 112 is not liable to be interfered by static electricity, and an optical taste of the touch display device 100 is improved.

The upper polarizing plate 114 is disposed at one side of the upper substrate 110 located away from the display medium 112. The upper polarizing plate 114 has an adhesion layer 128 to adhere the upper polarizing plate 114 and the upper substrate 110. A sheet resistance of the adhesion layer 128 is smaller than or equal to 10⁹Ω/□, which is unlikely to shield the touch sensing signal. In the present embodiment, the adhesion layer 128 has a plurality of antistatic particles to serve as a transmission path of the ESD. A material of the adhesion layer 128 is, for example, a pressure sensitive adhesive (PSA), though the invention is not limited thereto.

The signal transmission line 116 is disposed in the non-display area NDA of the touch display device 100. The signal transmission line 116 has a first end 116A, a second end 116B and a main body 116C. The first end 116A and the second end 116B are respectively located at two ends of the main body 116C, where the first end 116A is electrically connected to the adhesion layer 128, and the second end 116B is electrically connected to the lower substrate 102. To be specific, the first end 116A may directly contact the adhesion layer 128, and is fixed between the adhesion layer 128 and the upper substrate 110 through the adhesion layer 128, where the first end 116A is misaligned with the plurality of touch electrodes 108 in the direction perpendicular to the lower substrate 102, so as to reduce the influence on touch sensing. In an embodiment of the invention, the main body 116C of the signal transmission line 116 may directly contact the upper substrate 110, which avails improving the antistatic ability. Moreover, the touch display device 100 may further include a bonding part 130 located in the non-display area NDA. The bonding part 130 is disposed on the lower substrate 102. The second end 116B of the signal transmission line 116 can be electrically connected to the bonding part 130 to transmit signals (for example, static electricity) to external of the touch display device 100 through, for example, a flexible printed circuit (FPC) 132. In this way, when the touch display device 100 carries on an ESD withstand test according to test conditions listed in a following table 1, the touch display device 100 may withstand the ESD of 8 kV. In other words, the adhesion layer 128, the signal transmission line 116 and the bonding part 130 may construct an ESD path to avoid accumulation of the static electricity in the touch display device 100 to cause malfunction or damage thereof.

TABLE 1
Test condition (without including metal frame)

| | |
|---|---|
| Capacitance (pF) | 150_10% |
| Resistance (Ω) | 330_5% |
| Voltage (kV) | 4~12 |
| Charging times | 6 |
| Test environment | Air |

Moreover, in an embodiment of the invention, the touch display device 100 may further include a lower polarizing plate 134 disposed opposite to the upper polarizing plate 114. In detail, the lower polarizing plate 134 can be disposed on one side of the lower substrate 102 located away from the display medium 112 to locate opposite to the upper polarizing plate 114. The method of configuring the lower polarizing plate 134 on the lower substrate 102 can be the same to the method of configuring the upper polarizing plate 114 on the upper substrate 110, i.e. the lower polarizing plate 134 is adhered to the lower substrate 102 through an adhesion layer, though the invention is not limited thereto. Moreover, a polarization axis of the upper polarizing plate 114 and a polarization axis of the lower polarizing plate 134 can be orthogonal to each other to limit an amount of light passing there through.

In summary, in the touch display device of the invention, the upper polarizing plate has the adhesion layer with a sheet resistance smaller than or equal to 10⁹Ω/□, and Δε of the display medium is smaller than 0. In this way, in case of the ESD, the static electricity is transmitted to external of the touch display device without influencing a touch function, the display medium is not easy to be interfered by the ESD, and anti-ESD capability of the touch display device is improved and optical taste thereof is maintained.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

1. A touch display device, comprising:
a lower substrate;
an active device array, disposed on the lower substrate;
a passivation layer, covering the active device array;
a plurality of touch electrodes, disposed on the passivation layer;
an upper substrate, disposed opposite to the lower substrate;
a display medium, disposed between the upper substrate and the plurality of touch electrodes, and Δε of the display medium is smaller than 0;
an upper polarizing plate, disposed at one side of the upper substrate located away from the display medium, and having an adhesion layer to adhere the upper polarizing plate and the upper substrate, wherein a sheet resistance of the adhesion layer is smaller than or equal to 109Ω/□; and
a signal transmission line, disposed in a non-display area of the touch display device, and having a first end and a second end, wherein the first end is electrically connected to and directly contacts the adhesion layer, and the second end is electrically connected to the lower substrate.

2. The touch display device as claimed in claim 1, wherein the touch display device is adapted to withstand electrostatic discharge of 8 kV.

3. The touch display device as claimed in claim 1, wherein the plurality of touch electrodes comprise a plurality of sensing electrodes and a plurality of driving electrodes.

4. The touch display device as claimed in claim 1, wherein each active device in the active device array is overlapped with the plurality of touch electrodes in a direction perpendicular to the lower substrate.

5. The touch display device as claimed in claim 4, further comprising:
an insulation layer, disposed between the active devices and the plurality of touch electrodes to make the plurality of touch electrodes to be close to the upper substrate.

6. The touch display device as claimed in claim 1, wherein the adhesion layer has a plurality of antistatic particles.

7. (canceled)

8. The touch display device as claimed in claim 1, wherein the first end of the signal transmission line is misaligned with the plurality of touch electrodes in a direction perpendicular to the lower substrate.

9. The touch display device as claimed in claim 1, wherein the signal transmission line has a main body, the first end and the second end are located at two ends of the main body, and the main body directly contacts the upper substrate.

10. The touch display device as claimed in claim 1, further comprising:
a bonding part, disposed on the lower substrate and located in the non-display area, wherein the second end of the signal transmission line is electrically connected to the bonding part to transmit static electricity to external of the touch display device.
